(19) United States
(12) Patent Application Publication
(10) Pub. No.: US 2003/0052692 A1
(43) Pub. Date: Mar. 20, 2003

(54) Writing pen with a liquid crystal screen displaying the tested alcohol concentration value

(75) Inventor: Wen-Jung Lin, Taipei (TW)

Correspondence Address: BIRCH STEWART KOLASCH & BIRCH, PO BOX 747, FALLS CHURCH, VA, 22040-0747, US

(73) Assignee: SPEADA INDUSTRIAL CO. LTD.

(21) Appl. No.: 10/279,110

(22) Filed: Oct. 24, 2002

Related U.S. Application Data
(63) Continuation-in-part of application No. 09/778,093, filed on Feb. 7, 2001.

(51) Int. Cl. G01N 27/62

(52) U.S. Cl. 324/464

(57) ABSTRACT

The invention relates to a writing pen with a liquid crystal screen displaying the tested alcohol concentration value, and its architecture includes a lower barrel, an upper barrel, and a sensor device. The sensor device has a circuit board, wherein a sensor, a liquid crystal screen, and a processing unit are installed on and electrically connected to the circuit board. The circuit board receives the alcohol content in the user's exhaled breath and converts it so that a precise value can be displayed on the liquid crystal screen. Hence, a writing pen that can be readily carried and has a liquid crystal screen displaying the tested alcohol concentration value is completed.

### BACKGROUND OF THE INVENTION

The invention relates to a writing pen with a liquid crystal screen displaying the tested alcohol concentration value and, more particularly, to a pen with a testing function, which can be used for writing and has a liquid crystal screen displaying the precise value of alcohol concentration.

The U.S. Patent No. 6,142,951 titled “Directional baton with a breath analyzer” utilizes an alcohol sensor on the surface of a directional baton to measure the level of alcohol concentration of a user's breath. This invention decides the number of illumination generated by the light-emitting diodes according to a predetermined value of the directional baton so as to display an approximate level of the alcohol concentration from the user's exhaled breath. However, the directional baton can neither help the user measure the exact value of the alcohol concentration from his/her breath, nor can it perform other functions besides analyzing an approximate value of the alcohol concentration. In addition, because the directional baton is not a necessity of daily life, it usually will not be remembered until the user finds out that he/she has forgotten to bring it along for a social event. Moreover, the sensor of the directional baton is exposed on the surface of the baton's body; therefore, the performance of the sensor is prone to deteriorate easily due to the hitting and scratching from the external world. Furthermore, there is also a drawback of the directional baton; that is, because the criterion of the illumination generated by the baton is a predetermined value, the user may not be able to use the baton when the change of the established criterion occurs, such as from a law amendment or going abroad.

Also, another U.S. Patent No. 5,496,740 titled “Method and apparatus for determining the concentration of liquid systems” consists of a piston mechanism inside a pen-shaped body. When using the apparatus, a button located at one end of the pen-shaped body has to be pressed first, and through the sensor, the inside of the pen-shaped body is tested to see if there is any residual alcohol in it. The user has to wait until the sensor has displayed that there is no more residual alcohol left in the pen-shaped body, to insert the other end of the pen-shaped body into the mouth of the person being tested. After that, a latch is released so that the piston can be moved to draw the air of the mouth into the pen-shaped body, and through the sensor, the alcohol concentration of the drew-in breath can be tested. Although this invention has been improved by using a liquid crystal screen to display the alcohol level, the testing method is still considered to be unsanitary because the user has to insert the other end of the pen-shaped body into the mouth of the person being tested for drawing air. In addition, the tested value may be inaccurate because the amount of the drew-in breath may be varied due to an improper operation of the apparatus. Moreover, the apparatus is not a necessity of daily life, either. It has the shape of a pen but not the functionality of a pen, which means that it cannot be used for writing; consequently, a user will be less likely to carry it all the time.

### SUMMARY OF THE INVENTION

Therefore, the invention is to solve the above-mentioned problems as well as to prevent the drawback. The object of the invention is to provide a daily-used pen with a sensor device added to it, and a liquid crystal screen is on the sensor device, allowing the user easily to measure the precise value of his/her own alcohol concentration and to make self-control in drinking according to the precise value displayed on the liquid crystal screen. In addition, the invention adopts more than one alcohol concentration measures; therefore, when in manufacturing, one of the measures will be picked out for the country that uses it. Hence, a writing pen with a liquid crystal screen displaying the tested value of alcohol concentration can meet the requirements of modern people who pursue small, multifunctional, and portable necessities of daily life.

### BRIEF DESCRIPTION OF THE DRAWINGS

FIG. 1 is a schematic diagram showing the three-dimensional outline of the invention.

FIG. 2 is an exploded schematic diagram showing the architecture of the invention.

FIG. 3 is a partially sectional side view of the invention.

FIG. 4 is a flowchart showing the process of alcohol testing of the invention.

FIG. 5 is a diagram showing the circuits of the sensor device.

FIG. 6 is a table of the exact values of the converting measure device.

FIG. 7 is a schematic diagram showing the displaying modes of the liquid crystal screen of the invention.

### DESCRIPTION OF THE PREFERRED EMBODIMENTS

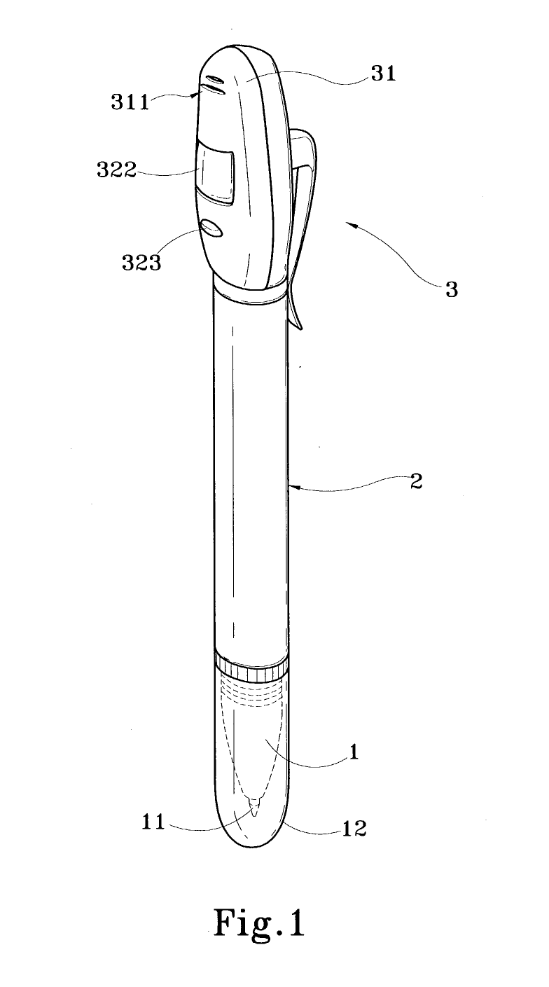

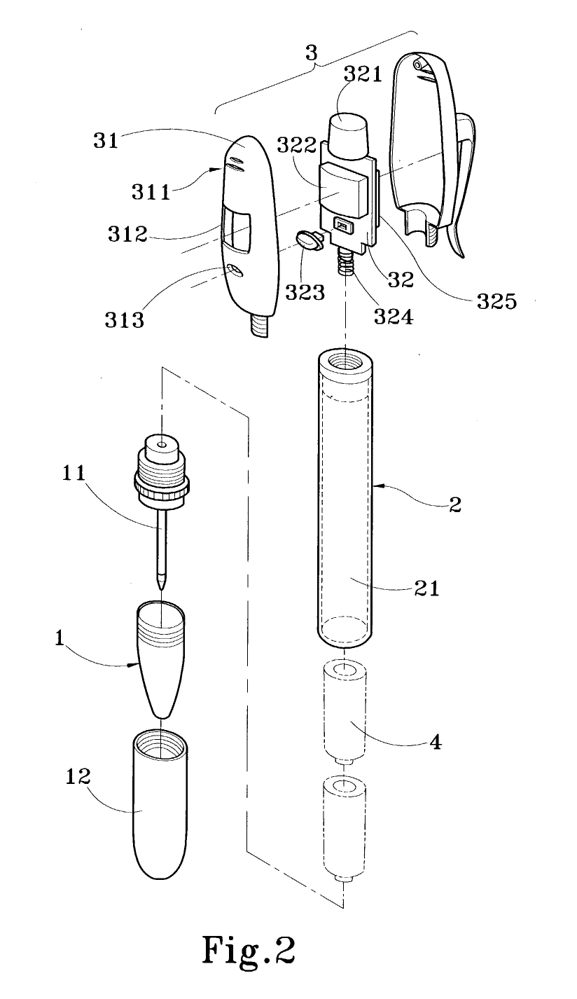

The detailed descriptions and technical contents of the invention will be described below with reference to the drawings. FIGS. 1 and 2 are schematic diagrams showing a three-dimensional outline and an exploded architecture of the invention respectively. As shown in both figures, a writing pen with a liquid crystal screen displaying the tested alcohol concentration value according to the embodiment of the invention includes:

a lower barrel 1, which has a cartridge 11 placed therein; the outer portion of the lower barrel 1 is engaged with a pen cap 12, which allows the lower barrel 1 to be placed inside the pen cap 12, and the pen cap 12 can be engaged with the outer portion of the lower barrel 1 by either one of the methods of screw connection, tightly fitting-in, magnetic force, etc., whereas the pen can be used for writing when the pen cap 12 is removed;

an upper barrel 2, which is engaged with one end of the lower barrel 1, and a battery chamber 21 is placed inside the upper barrel 2 for accommodating the battery 4;

a sensor device 3, which is engaged with the other end of the upper barrel 2 and has a housing 31 and a circuit board 32; a gas convection slot 311, a panel opening 312, and a switch slot 313 are located on the housing 31; the circuit board 32 is installed inside the housing 31, while a sensor 321, a liquid crystal screen 322 that fits in the panel opening 312, and an activating switch 323 that fits in the switch slot 313 are installed on and electrically connected to the circuit board 32; the sensor 321 can be a semiconductor sensor, which generates different voltages according to different levels of alcohol concentration and transmits the voltages to the circuit board 32; the circuit board 32 has a processing unit 325, an electrode 324, and an automatic power-off device (not shown) placed on it; the processing unit 325 has a converting function, which converts the different voltages from different alcohol concentration levels into digital data and outputs the precise value of the alcohol concentration to the liquid crystal screen 322; the electrode 324 is connected to the battery 4 so as to conduct the sensor device 3. Hence, the architecture of the writing pen with a liquid crystal screen displaying the tested alcohol concentration value is completed.

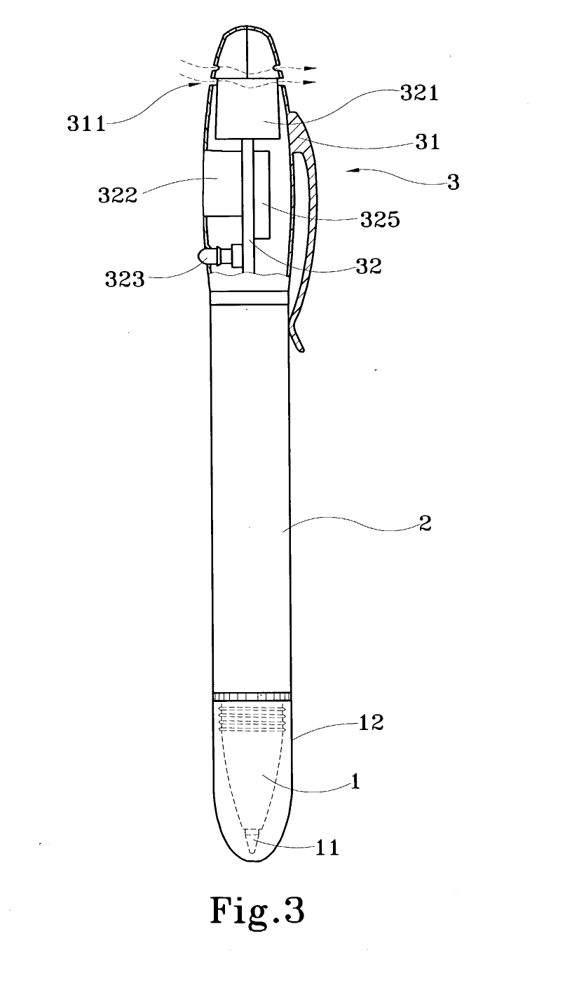

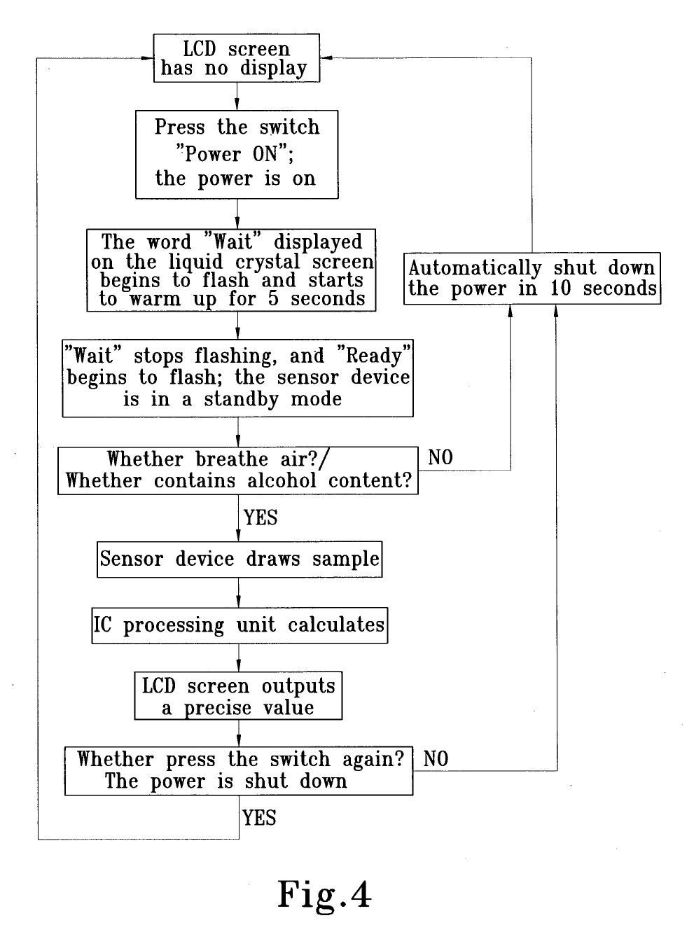

FIGS. 3, 4 and 5 include a partially sectional side view, an alcohol-testing flowchart, and a sensor device circuit diagram of the invention. As shown in the figures, when in a normal situation, the liquid crystal screen 322 has no display. As soon as the user presses the activating switch 323, the power is on, the sensor 321 is activated, the word “Wait” on the liquid crystal screen 322 will also begin to flash, and the sensor device will be warmed up for 5 to 8 seconds. When the word “Wait” stops flashing, the word “Ready” will begin to flash, and at this moment, the sensor device will return to zero as a standby mode, waiting for the user's next action. If the user dose not continue to use the sensor device or the user's exhaled breath dose not contain alcohol, the automatic power-off device 327 will shut down the power in ten seconds, and again the liquid crystal screen 322 will have no display. When the user breathes against the gas convection slot 311 in a standby mode, his/her exhaled breath will contact the sensor 321. If the exhaled breath contains alcohol concentration, the sensor 321 will generate a voltage corresponding to the level of alcohol concentration. After the voltage has been transmitted to the circuit board 32, the processing unit 325 will convert the voltage into a digital data and output a precise value in a decimal code on the liquid crystal screen 322. At this time, if the activating switch 323 is pressed again, the power of the sensor device 3 will be shut down, and the liquid crystal screen 322 will have no display. Conversely, if the activating switch 323 is not pressed, the automatic power-off device 327 will shut down the power in ten seconds, and the liquid crystal screen will have no display. Thus, the purpose of testing the precise value of alcohol concentration in the user's breath has been achieved.

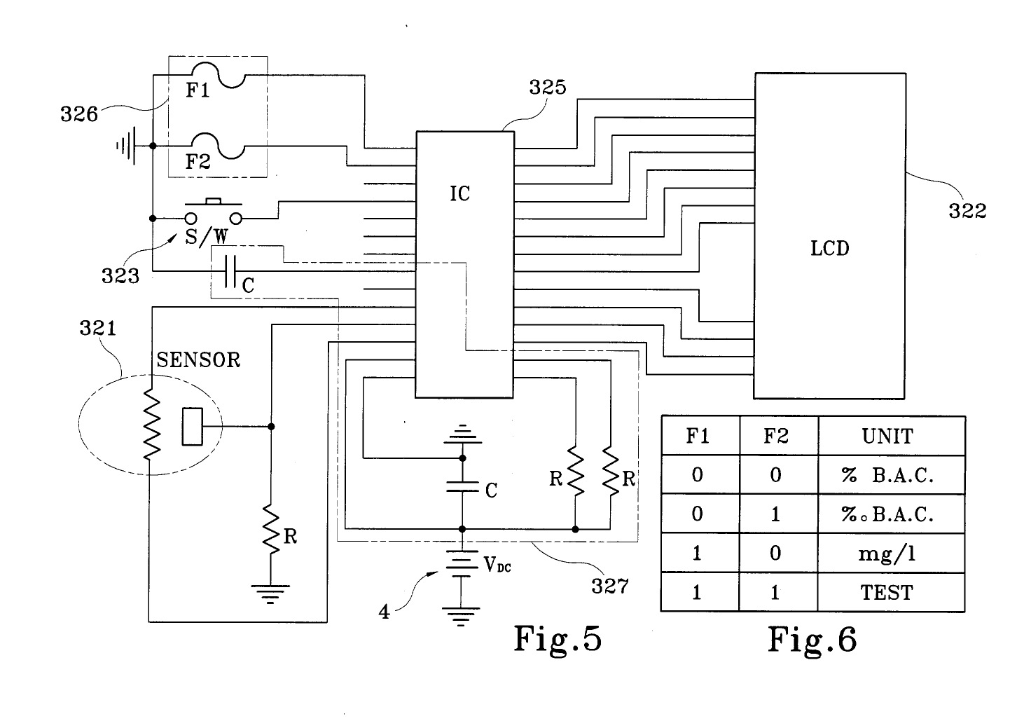

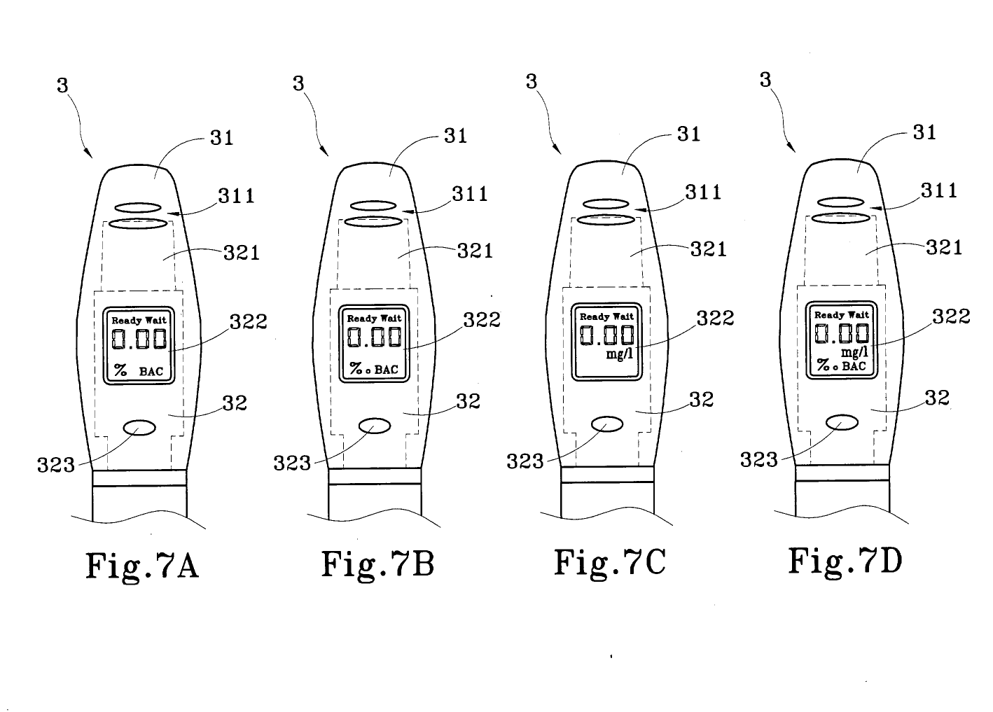

FIGS. 5, 6 and 7 include a circuit diagram of the sensor device, a table of the exact values of the converting measure device, and a schematic diagram showing the displaying modes of the liquid crystal screen of the invention. As shown in the figures, the converting measure device 326 of the invention has a first fuse F1 and a second fuse F2. When in manufacturing, and when the first fuse F1 and the second fuse F2 are in a break mode, the measure being generated is “% B.A.C” blood alcohol content, its testing range is from 0 to 0.4% B.A.C., and the display on the liquid crystal screen 322 is shown in FIG. 7A. When the first fuse F1 is in a break mode and the second fuse F2 in a conducting mode, the measure being generated is “% 0 B.A.C.” blood alcohol content, its testing range is from 0 to 4.0% B.A.C., and the display on the liquid crystal screen 322 is shown in FIG. 7B. When the first fuse F1 is in a conducting mode and the second fuse F2 in a break mode, the measure being generated is “mg/l” alcohol in breath, its testing range is from 0 to 2.0 mg/I, and the display on the liquid crystal screen 322 is shown in FIG. 7C. When the first fuse F1 and the second fuse F2 are both in a conducting mode, all the measures will be displayed on the liquid crystal screen 322 to check if the display of the liquid crystal screen 322 is normal, which is shown in FIG. 7D.

What is claimed is:

1. A writing pen with a liquid crystal screen displaying the tested alcohol concentration value, including:
a lower barrel;
an upper barrel, which is engaged with one end of the lower barrel; and
a sensor device, which is engaged with the other end of the upper barrel and has a housing and a circuit board; a gas convection slot and a panel opening are located on the housing, whereas the circuit board is installed inside the housing; a sensor and a liquid crystal screen that fits in the panel opening are installed on and electrically connected to the circuit board;
when the sensor device is in the standby mode, the user breathes against the gas convection slot, and through the sensor, the level of the alcohol concentration in the user's exhaled breath can be received to a processing unit to be converted into a precise value so that the sensor device can display the precise value on the liquid crystal screen; hence, the purpose of testing the precise value of the alcohol concentration in the user's breath has been achieved.

2. The writing pen with a liquid crystal screen displaying the tested alcohol concentration value as claimed in claim 1, wherein a cartridge is placed inside the lower barrel for writing, whereas the outer portion of the lower barrel is engaged with a pen cap, which allows the lower barrel to be placed therein.

3. The writing pen with a liquid crystal screen displaying the tested alcohol concentration value as claimed in claim 2, wherein the cartridge of the lower barrel can be a fountain pen, a ball pen, or a pencil.

4. The writing pen with a liquid crystal screen displaying the tested alcohol concentration value as claimed in claim 2, wherein the pen cap can be engaged with the outer portion of the lower barrel by either one of the methods of screw connection, tightly fitting-in, magnetic force.

5. The writing pen with a liquid crystal screen displaying the tested alcohol concentration value as claimed in claim 1, wherein a battery chamber is placed inside the upper barrel.

6. The writing pen with a liquid crystal screen displaying the tested alcohol concentration value as claimed in claim 5, wherein the battery chamber can be placed in more than one battery.

7. The writing pen with a liquid crystal screen displaying the tested alcohol concentration value as claimed in claim 1, wherein the housing of the sensor device may have a switch slot.

8. The writing pen with a liquid crystal screen displaying the tested alcohol concentration value as claimed in claim 1, wherein the circuit board of the sensor device has an activating switch that fits in the switch slot.

9. The writing pen with a liquid crystal screen displaying the tested alcohol concentration value as claimed in claim 8, wherein the activating switch can be a press-down switch.

10. The writing pen with a liquid crystal screen displaying the tested alcohol concentration value as claimed in claim 1, wherein the housing of the sensor device may be integrally formed with the circuit board, or the housing may be placed on each of the two sides of the circuit board to cover the circuit board.

11. The writing pen with a liquid crystal screen displaying the tested alcohol concentration value as claimed in claim 1, wherein the circuit board has a processing unit and an automatic power-off device.

12. The writing pen with a liquid crystal screen displaying the tested alcohol concentration value as claimed in claim 1, wherein at least one electrode is provided on the circuit board and electrically connected to the battery in the battery chamber.

13. The writing pen with a liquid crystal screen displaying the tested alcohol concentration value as claimed in claim 1, wherein the liquid crystal screen has more than one measure of alcohol concentration for displaying.
